(19) United States
(12) Patent Application Publication
(10) Pub. No.: US 2018/0091257 A1
(43) Pub. Date: Mar. 29, 2018

(54) MU RATE ADAPTATION WITH TRANSMISSION POWER AWARENESS

(71) Applicant: QUALCOMM Incorporated, San Diego, CA (US)

(72) Inventors: Gregory Steele, Pleasanton, CA (US); Ahmed Ragab Elsherif, San Jose, CA (US)

(21) Appl. No.: 15/277,084

(22) Filed: Sep. 27, 2016

(51) Int. Cl. H04L 1/00; H04L 12/26; H04B 7/04; H04W 52/24

(52) U.S. Cl. CPC H04L 1/0015; H04L 43/0829; H04W 88/08; H04W 52/24; H04B 7/0452

(57) ABSTRACT

A method for multi-user multiple-input multiple-output (MU-MIMO) communications between a communications device and a client station (STA). The communications device may initiate MU-MIMO transmissions to the STA according to a first modulation and coding scheme (MCS) and a first transmission power. The device may monitor packet error rates (PERs) associated with the MU-MIMO transmissions to the STA and select a second MCS to be used for subsequent MU-MIMO transmissions to the STA based, at least in part, on the PERs and the first transmission power. The device may determine a target transmission power associated with the first MCS and compare the target transmission power with the first transmission power. The selection of the second MCS may be based, at least in part, on the comparison. The device may record PERs associated with the MU-MIMO transmissions, in a PER table, in relation to the first transmission power.

### TECHNICAL FIELD

The present embodiments relate generally to wireless communications systems, and specifically to methods of multi-user rate adaptation based on transmission power.

### BACKGROUND OF RELATED ART

Multiple-input multiple-output (MIMO) wireless communications techniques are used in local area networks (LANs) and 4G cellular networks to enable an access point (AP) to transmit multiple streams of data, concurrently, to a client or user station (STA). MIMO communications offer many advantages over conventional communications techniques, including, for example, high capacity, extended coverage, increased diversity, and/or interference suppression. As a result, multi-user MIMO (MU-MIMO) has emerged as an important feature of next-generation wireless networks. MU-MIMO has the potential to combine the high capacity of MIMO processing with the benefits of space-division multiple access (SDMA).

For MU-MIMO communications, multiple data streams may be transmitted from an AP to two or more STAs, concurrently. For example, the AP may use beamforming techniques to transmit multiple concurrent data streams to spatially diverse STAs at substantially the same time. Such devices may be collectively referred to as a multi-user (MU) group. Each STA in an MU group may support a particular modulation and coding scheme (MCS), which may be different than the MCSs supported by other STAs in the MU group. The transmission power of the MU transmission is determined to meet the linearity requirements of the highest MCS in the MU group.

Since a particular STA may belong to multiple MU groups, the STA may receive separate MU-MIMO transmissions (e.g., directed at the different MU groups) using the same MCS but at different transmission powers. Due to the differences in transmission power, the STA may report different packet error rates (PERs) for the separate MU-MIMO transmissions even though they may be transmitted using the same MCS.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A method for multi-user multiple-input multiple-output (MU-MIMO) communications between a wireless communications device and a client station (STA) is disclosed. The wireless communications device may initiate MU-MIMO transmissions to the STA according to a first modulation and coding scheme (MCS) and a first transmission power, monitor packet error rates (PERs) associated with the MU-MIMO transmissions to the STA and select a second MCS to be used for subsequent MU-MIMO transmissions to the STA based, at least in part, on the PERs and the first transmission power. The initial MU-MIMO transmissions may be intended for the STA as a member of a first MU group, and the subsequent MU-MIMO transmissions may be intended for the STA as a member of a second MU group.

In some aspects, the wireless communications device may determine a target transmission power associated with the first MCS, compare the target transmission power with the first transmission power and select the second MCS based, at least in part, on the comparison. The wireless communications device may use the PERs associated with the MU-MIMO transmissions, in selecting the second MCS, if the target transmission power and the first transmission power are substantially the same. On the other hand, the wireless communications device may ignore the PERs associated with the MU-MIMO transmissions, in selecting the second MCS, if the target transmission power and the first transmission power are different.

The wireless communications device may selectively record the PERs in a PER table based on the first transmission power. In some aspects, the wireless communications device may record the PERs associated with the MU-MIMO transmissions, in a PER table, in relation to the first transmission power. In other aspects, the wireless communications device may record the PERs associated with the MU-MIMO transmissions, in the PER table, in relation to a group size associated with the MU-MIMO transmissions. Further, the wireless communications device may determine a target transmission power associated with the first MCS. In some aspects, the wireless communications device may record the PERs associated with the MU-MIMO transmissions in the PER table if the first transmission power and the target transmission power are substantially the same. In other aspects, the wireless communications device may discard the PERs associated with the MU-MIMO transmissions from the PER table if the first transmission power and the target transmission power are different.

The methods and systems of operation disclosed herein allow a wireless communications device (e.g., AP) to select a MCS to be used for MU-MIMO transmissions to a particular STA based at least in part on the transmission power of the MU-MIMO transmissions. For example, by taking into account the transmission power of MU-MIMO transmissions to different MU groups, the AP may effectively ignore the PER of MU-MIMO transmissions to a particular STA (e.g., that may be attributed to changes in transmission power) when the MU-MIMO transmissions are not at the target transmission power for the given MCS. This allows the AP to more accurately determine how to adjust the MCS for the STA for subsequent data transmissions. Furthermore, by tracking the transmission power in relation to the PERs and group size associated with the MU-MIMO transmissions, the AP may dynamically adjust the MCS for a particular STA in an MU group.

### BRIEF DESCRIPTION OF THE DRAWINGS

The present embodiments are illustrated by way of example and are not intended to be limited by the figures of the accompanying drawings, where:

FIG. 1 shows a communications system in accordance with example embodiments.

FIG. 2 shows a timing diagram depicting an example MCS selection/adjustment operation.

FIG. 3 shows a block diagram of a wireless communications device in accordance with example embodiments.

FIG. 4 shows an example PER table that may be used to record PERs of wireless communications with a particular STA, in accordance with some embodiments.

FIG. 5 shows a timing diagram depicting an example power-based MCS selection/adjustment operation, in accordance with some embodiments.

FIG. 6 shows an example PER table that may be used to record PERs of wireless communications with a particular STA, in accordance with other embodiments.

FIG. 7 shows a timing diagram depicting an example power-based MCS selection/adjustment operation, in accordance with other embodiments.

FIG. 8 is an illustrative flowchart depicting a method for MU-MIMO communications with a particular station, in accordance with example embodiments.

FIG. 9 is an illustrative flowchart depicting a method for selecting an MCS to be used for MU-MIMO transmissions based on transmission power, in accordance with some embodiments.

FIG. 10 is an illustrative flowchart depicting a method of selecting an MCS to be used for MU-MIMO transmissions based on transmission power, in accordance with other embodiments.

### DETAILED DESCRIPTION

The example embodiments are described below in the context of WLAN systems for simplicity only. It is to be understood that the example embodiments are equally applicable to other wireless networks (e.g., cellular networks, pico networks, femto networks, satellite networks), as well as for systems using signals of one or more wired standards or protocols (e.g., Ethernet and/or HomePlug/PLC standards). As used herein, the terms “WLAN” and “Wi-Fi®” may include communications governed by the IEEE 802.11 family of standards, BLUETOOTH® (Bluetooth), HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. In addition, although described below in terms of an infrastructure WLAN system including one or more APs and a number of STAs, the example embodiments are equally applicable to other WLAN systems including, for example, multiple WLANs, peer-to-peer (or Independent Basic Service Set) systems, Wi-Fi Direct systems, and/or Hotspots.

In addition, although described herein in terms of exchanging data frames between wireless devices, the example embodiments may be applied to the exchange of any data unit, packet, and/or frame between wireless devices. Thus, the term “frame” may include any frame, packet, or data unit such as, for example, protocol data units (PDUs), MAC protocol data units (MPDUs), and physical layer convergence procedure protocol data units (PPDUs). The term “A-MPDU” may refer to aggregated MPDUs. In the following description, numerous specific details are set forth such as examples of specific components, circuits, and processes to provide a thorough understanding of the present disclosure. The term “coupled” as used herein means connected directly to or connected through one or more intervening components or circuits.

Also, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory. These descriptions and representations are the means used by those skilled in the art to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the example wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

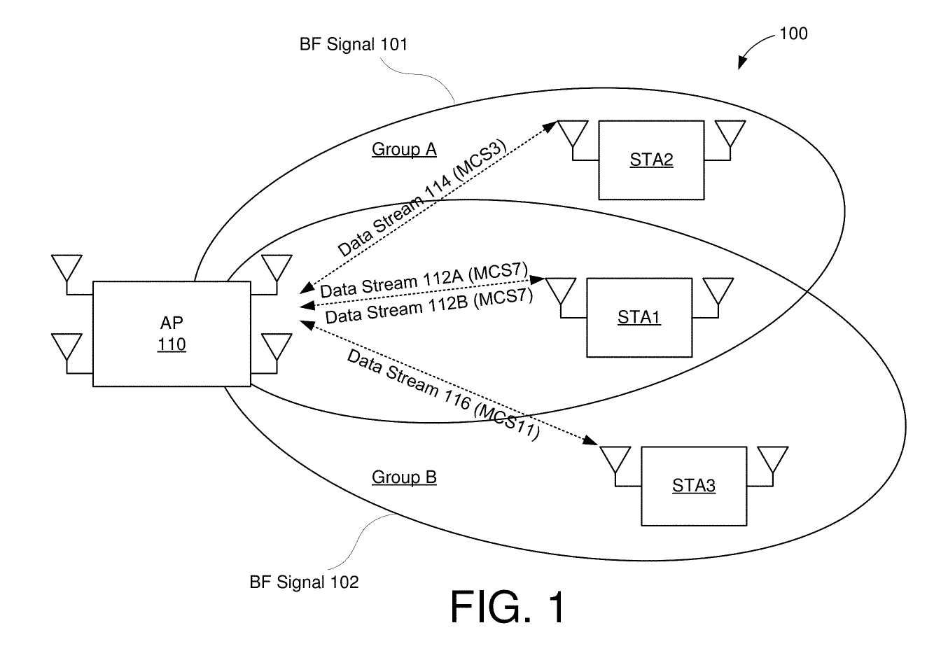

FIG. 1 shows a communications system 100 in accordance with example embodiments. The communications system 100 includes an access point (AP) 110 and user stations STA1, STA2 and STA3. The AP 110, STA1, STA2 and STA3 may be, for example, computers, switches, routers, hubs, gateways, smartphones, tablets and/or similar devices. For some embodiments, the communications system 100 may correspond to a multi-user multiple-input multiple-output (MU-MIMO) wireless network (e.g., as defined by the IEEE 802.11ac specification). Thus, the communications system 100 may include additional STAs and/or APs (not shown for simplicity).

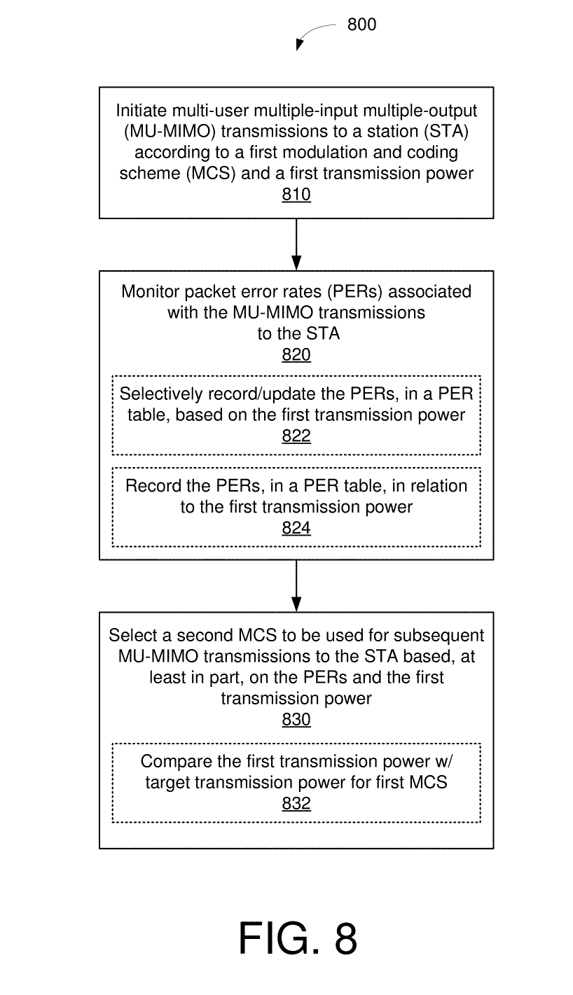

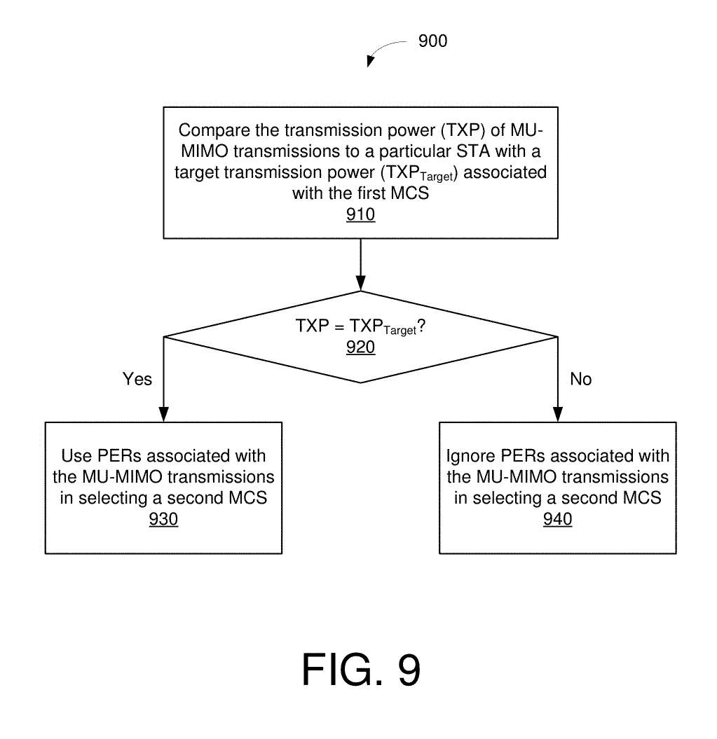

Each of the stations STA1-STA3 may be any suitable Wi-Fi enabled wireless device including, for example, a cell phone, personal digital assistant (PDA), tablet device, laptop computer, or the like. Each station STA may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, each station STA may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 8-9.

The AP 110 may be any suitable device that allows one or more wireless devices to connect to a network (e.g., a local area network (LAN), wide area network (WAN), metropolitan area network (MAN), and/or the Internet) via AP 110 using Wi-Fi, Bluetooth, or any other suitable wireless communication standards. For at least one embodiment, AP 110 may include one or more transceivers, a network interface, one or more processing resources, and one or more memory resources. The one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. The memory resources may include a non-transitory computer-readable medium (e.g., one or more nonvolatile memory elements, such as EPROM, EEPROM, Flash memory, a hard drive, etc.) that stores instructions for performing operations described operations described above or below with respect to FIGS. 8-9.

For the AP 110 and/or stations STA1-STA3, the one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band and/or within a 5 GHz frequency band in accordance with the IEEE 802.11 specification. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers may be any technically feasible transceiver such as a ZigBee transceiver described by a specification from the ZigBee specification, a WiGig transceiver, and/or a HomePlug transceiver described a specification from the HomePlug Alliance.

For some embodiments, the AP 110 may communicate with each of the stations STA1-STA3 using MU-MIMO communication techniques. For example, stations STA1 and STA2 may belong to a first MU group (Group A) and stations STA1 and STA3 may belong a second MU group (Group B). When communicating with Group A, the AP 110 may transmit a first beamformed (BF) signal 101 to stations STA1 and STA2. For example, the first BF signal 101 may include data streams 112A and 114 (e.g., transmitted as multiple concurrent spatial streams) intended for stations STA1 and STA2, respectively. When communicating with Group B, the AP 110 may transmit a second beamformed (BF) signal 101 to stations STA1 and STA3. For example, the second BF signal 102 may include data streams 112B and 116 intended for stations STA1 and STA3, respectively.

Each of the data streams 112A/B, 114, and 116 may be transmitted and/or encoded in accordance with a modulation and coding scheme (MCS) specific to the intended STA. In the example of FIG. 1, data stream 114 may be transmitted according to a first MCS (MCS3), data stream 116 may be transmitted according to a second MCS (MCS11), and data streams 112A and 112B may be transmitted according to a third MCS (MCS7). The AP 110 may select the MCS (e.g., data rate) for each STA based on a number of factors including, for example, channel state information (CSI), signal strength, and packet error rate (PER). More specifically, the AP 110 may “adjust” the MCS for a particular STA (e.g., by selecting a new MCS after a given interval) based at least in part on a moving average of the PERs measured over the given interval.

PER represents the number of incorrectly received data packets divided by the total number of received packets. PER may be affected by, among other factors, the channel estimation (e.g., whether the BF signals 101 and 102 accurately track the members of Group A and Group B, respectively) and the selected MCS (e.g., whether the data rate is appropriate for the particular STA given current channel conditions). A relatively low PER (e.g., below a PER threshold—PER_{TH}) may indicate that a corresponding MCS is well-suited for the MU-MIMO transmissions to a particular STA, whereas a relatively high PER (e.g., above PER_{TH}) may indicate that the corresponding MCS is not well-suited for the MU-MIMO transmissions to the STA. Thus, if the AP 110 detects a significantly high PER for a particular STA (e.g., the average PER exceeds PER_{TH}), the AP 110 may reduce the MCS or data rate of transmissions to that STA (e.g., to compensate for the drop in goodput).

Each MCS may be associated with an “ideal” or target transmission power (TXP) that optimizes the robustness and/or quality of MU-MIMO transmissions for the given MCS. For example, MU-MIMO transmissions using MCS7 may be ideally transmitted at 15 dBm, whereas MU-MIMO transmissions using MCS11 may be ideally transmitted at 10 dBm. Each of the BF signals 101 and 102 is typically transmitted at a single transmission power. Accordingly, any data streams that are transmitted as part of the same beamformed signal will have the same transmission power. Conventionally, the transmission power of a beamformed signal may correspond with the target transmission power associated with the highest MCS used in any of the MU-MIMO transmissions (e.g., data streams) for a particular MU group.

Thus, in the example of FIG. 1, BF signal 101 may be transmitted at the target transmission power for MCS7 (e.g., the highest MCS associated with Group A), whereas BF signal 102 may be transmitted at the target transmission power for MCS11 (e.g., the highest MCS associated with Group B). Since STA1 is a member of Group A and Group B, STA1 receive the data streams 112A and 112B at two different transmission powers (e.g., 15 dBm and 10 dBm, respectively), albeit using the same MCS (e.g., MCS7). As a result, STA1 may report substantially different PERs for the same MCS (e.g., MCS7) based on varying transmission powers.

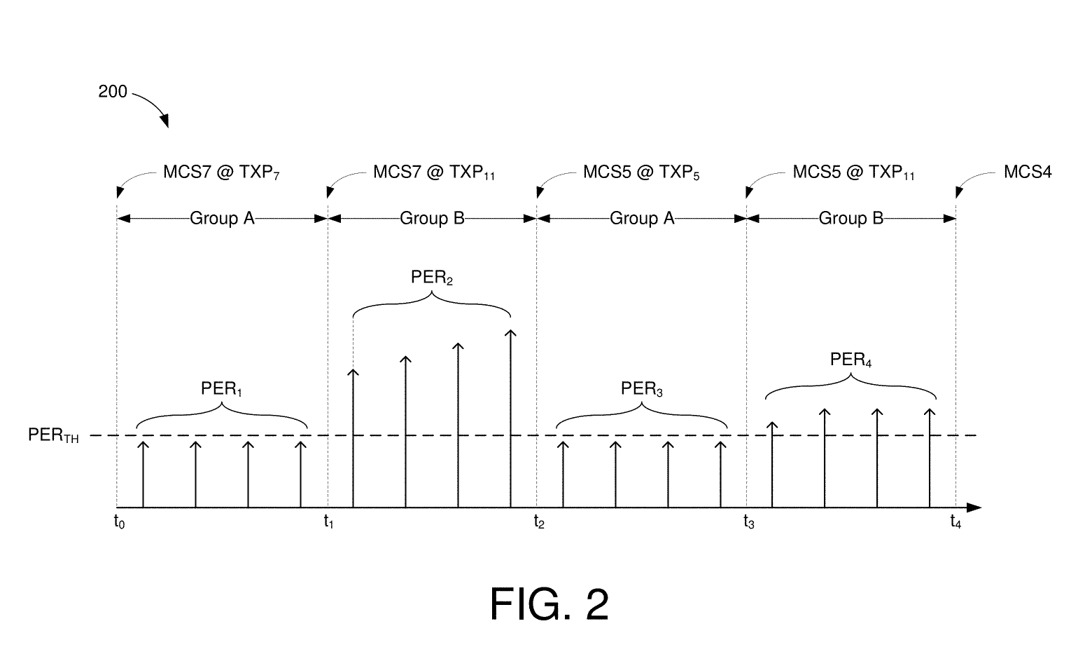

FIG. 2 shows a timing diagram 200 depicting an example MCS selection/adjustment operation. With reference, for example, to FIG. 1, the example operation of FIG. 2 may be performed by the AP 110 to selectively adjust an MCS to be used for MU-MIMO transmissions to STA1 based on the packet error rates of prior MU-MIMO transmissions to STA1. For purposes of discussion, it may be assumed that the MCSs associated with the other stations STA2 and STA3 remain unchanged throughout the example of FIG. 2. For example, the AP 110 may use MCS3 for MU-MIMO transmissions to STA2, and MCS11 for MU-MIMO transmissions to STA3, for the entirety of the duration shown in FIG. 2 (e.g., from times t₀ to t₄).

At time t₀, the AP 110 may initiate a MU-MIMO transmission to STA1 as part of a beamformed signal intended for Group A (e.g., BF signal 101). MCS7 may be used for the MU-MIMO transmission (e.g., corresponding to the highest MCS currently supported by STA1). Because MCS7 is also the highest MCS associated with Group A, the MU-MIMO transmission may be at the target transmission power for MCS7 (e.g., TXP₇). The AP 110 may measure a first set of PERs (e.g., PER₁) associated with the MU-MIMO transmission to determine, at time t₁, whether to adjust the MCS for STA1. Since the first set of PERs (measured from times t₀ to t₁) is below the PER threshold (PER_{TH}), AP 110 may continue using MCS7 for subsequent MU-MIMO transmissions to STA1.

At time t₁, the AP 110 may initiate a second MU-MIMO transmission to STA1 as part of a beamformed signal intended for Group B (e.g., BF signal 102). MCS7 may again be used for the second MU-MIMO transmission (e.g., since no adjustments were made based on PER₁). However, because MCS11 is the highest MCS associated with Group B, the second MU-MIMO transmission may be at the target transmission power for MCS11 (e.g., TXP₁₁). The AP 110 may measure a second set of PERs (e.g., PER₂) associated with the second MU-MIMO transmission to determine, at time t₂, whether to adjust the MCS for STA1. Since the second set of PERs (measured from times t₁ to t₂) is above PER_{TH}, under conventional implementations the AP 110 may reduce the MCS (e.g., to MCS5) for subsequent MU-MIMO transmissions to STA1. More specifically, conventional methods of MCS selection/adjustment do not account for the effects of transmission power on the measured PERs. For example, because the transmission power of the second MU-MIMO transmission is not ideal for the given MCS (e.g., TXP₁₁<TXP₇), the measured PERs for the second MU-MIMO transmissions may be substantially higher than they otherwise would be at the target transmission power.

At time t₂, the AP 110 may initiate a third MU-MIMO transmission to STA1 as part of a beamformed signal intended for Group A (e.g., BF signal 101). MCS5 may be used for the third MU-MIMO transmission. Because MCS5 is also the highest MCS associated with Group A, the third MU-MIMO transmission may be at the target transmission power for MCS5 (e.g., TXP₅). The AP 110 may measure a third set of PERs (e.g., PER₃) associated with the third MU-MIMO transmission to determine, at time t₃, whether to adjust the MCS for STA1. Since the third set of PERs (measured from times t₂ to t₃) is below PER_{TH}, the AP 110 may continue using MCS5 for subsequent MU-MIMO transmissions to STA1.

At time t₃, the AP 110 may initiate a fourth MU-MIMO transmission to STA1 as part of a beamformed signal intended for Group B (e.g., BF signal 102). MCS5 may continue to be used for the fourth MU-MIMO transmission. However, because MCS11 is the highest MCS associated with Group B, the fourth MU-MIMO transmission may be at the target transmission power for MCS11 (e.g., TXP₁₁). The AP 110 may measure a fourth set of PERs (e.g., PER₄) associated with the fourth MU-MIMO transmission to determine, at time t₄, whether to adjust the MCS for STA1. As described above, conventional methods of MCS selection/adjustment do not account for the effects of transmission power on the measured PERs. Thus, because the fourth set of PERs (measured from times t₃ to t₄) is above PER_{TH}, under conventional implementations the AP 110 may further reduce the MCS (e.g., to MCS4) for subsequent MU-MIMO transmission to STA1.

As shown in FIG. 2, the AP 110 may continue to reduce the MCS for STA1 based on the PERs measured for MU-MIMO transmissions to STA1 as a member of Group B, even though the PERs measured for MU-MIMO transmissions to STA1 as a member of group A are consistently below the PER threshold. As described above, the fluctuations in PER may be attributed to the differences in transmission power used to transmit BF signals 101 and 102 to Groups A and B, respectively. For example, using a lower transmission power than the target transmission power is likely to result in higher PERs for MU-MIMO transmissions at a given MCS. However, when the MU-MIMO transmissions are not at the ideal transmission power, the PERs associated with such MU-MIMO transmissions may not accurately reflect the performance of the corresponding MCS. Thus, it may not be desirable to adjust the MCS for a particular STA based on PERs measured for MU-MIMO transmissions at a non-ideal transmission power.

In example embodiments, the AP 110 may selectively adjust the MCS for a particular STA based at least in part on a transmission power of prior MU-MIMO transmissions to the STA. For example, when determining whether to adjust (e.g., increase, decrease, or maintain) the MCS for a STA, the AP 110 may ignore any PERs measured for MU-MIMO transmissions at non-ideal transmission powers. More specifically, the AP 110 may consider the PERs only if the MU-MIMO transmissions were at an ideal or target transmission power for the given MCS used for such MU-MIMO transmissions. In some aspects, the AP 110 may store the transmission power associated with each MU-MIMO transmission in a PER table. In other aspects, the AP 110 may discard, from the PER table, any PER records that are not associated with the target transmission power for a given MCS.

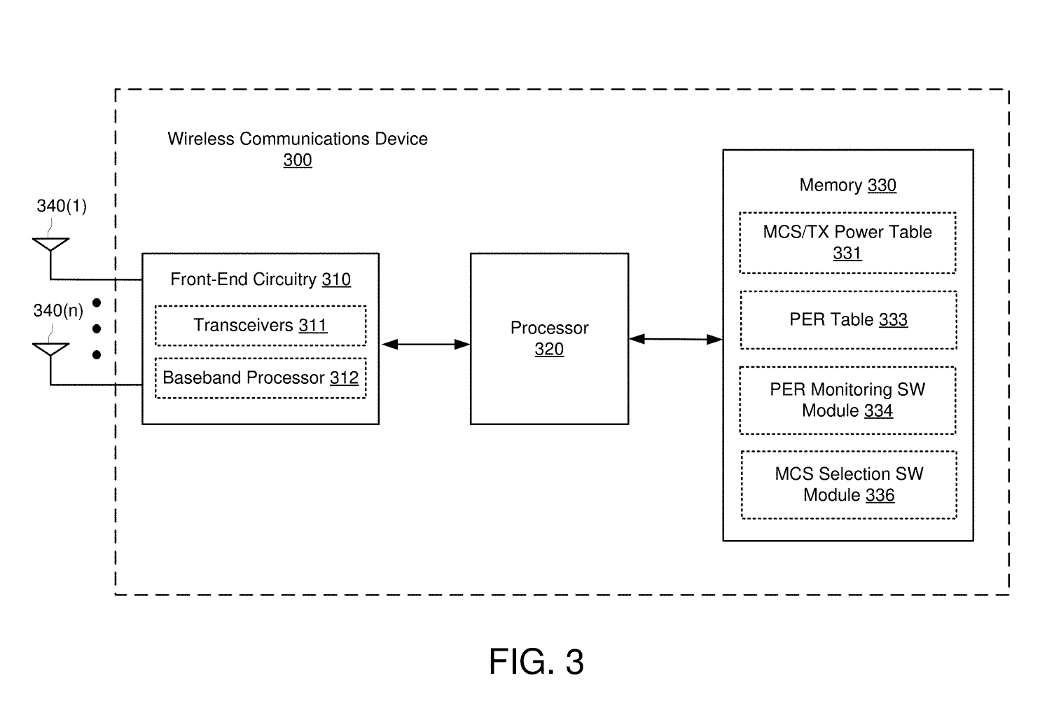

FIG. 3 shows a block diagram of a wireless communications device 300 in accordance with example embodiments. The wireless communications device 300 may be an embodiment of AP 110 and/or one of the stations STA1-STA3 of FIG. 1. The wireless communications device 300 includes front-end circuitry 310 coupled to a number of antennas 340(1)-340(n), a processor 320, and a memory 330. For purposes of discussion herein, processor 320 is shown in FIG. 3 as being coupled between front-end circuitry 310 and memory 330. For actual embodiments, the front-end circuitry 310, processor 320, and/or memory 330 may be connected together using one or more buses (not shown for simplicity).

The front-end circuitry 310 may include one or more transceivers 311 and a baseband processor 312. The transceivers 311 may be coupled to antennas 340(1)-340(n), either directly or through an antenna selection circuit (not shown for simplicity). The transceivers 311 may be used to communicate wirelessly with one or more STAs, APs, and/or other suitable wireless devices. The baseband processor 312 may also be used to process signals received from one or more of the antennas 340(1)-340(n) via transceivers 311 and to forward the processed signals to processor 320 and/or memory 330. In example embodiments, the front-end circuitry 310 may be configured to transmit and encode MU-MIMO signals (e.g., using beamforming techniques), SU-MIMO signals, and/or open loop communications.

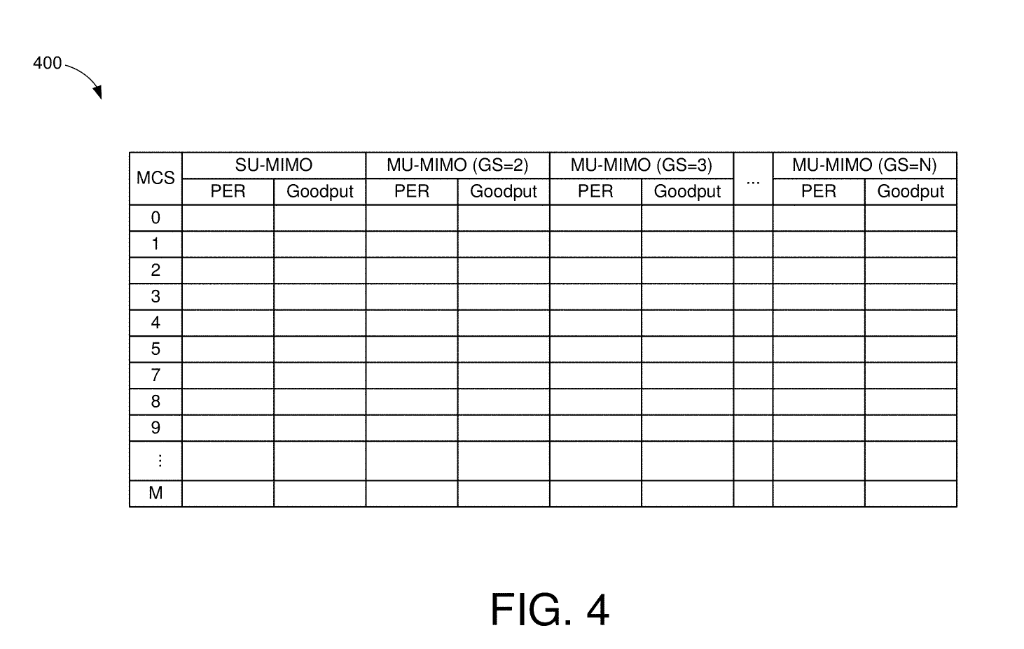

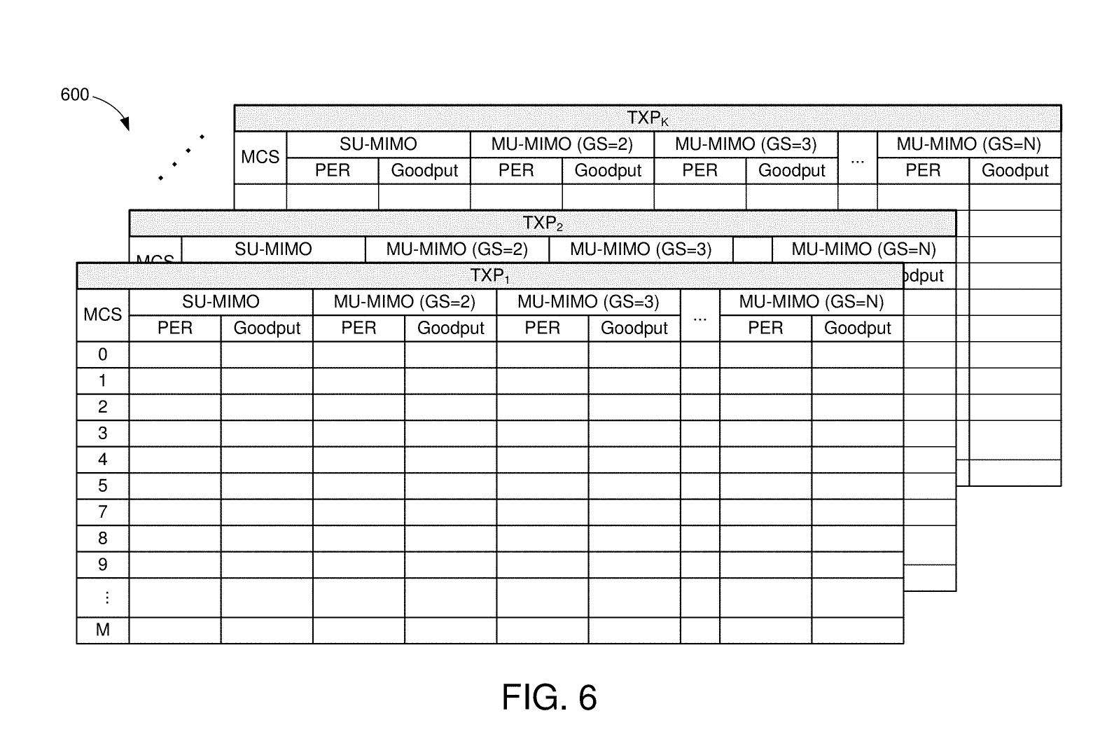

Memory 330 may include an MCS/TX Power Table 331 for storing target transmission power values for corresponding MCS index values. In general, higher MCS index values may be associated with lower target transmission powers, whereas lower MCS index values may be associated with higher target transmission powers. Memory 330 may also include a PER table 333 for storing PER records in accordance with the embodiments discussed below with respect to FIG. 4 and FIG. 6. In example embodiments, the PER table 333 may also store a transmission power associated with each PER record (e.g., indicating the transmission power of the MU-MIMO transmissions for which the PERs are recorded).

Memory 330 may also include a non-transitory computer-readable medium (e.g., one or more nonvolatile memory elements, such as EPROM, EEPROM, Flash memory, a hard drive, etc.) that may store at least the following software (SW) modules:
a PER monitoring SW module 334 to monitor PERs associated with MU-MIMO transmissions and a transmission power of the MU-MIMO transmissions;
an MCS selection SW module 336 to adjust the MCS used for transmitting data to the STA (e.g., by selecting a new MCS) based at least in part on the PERs and transmission power associated with the MU-MIMO transmissions; and
   Each software module includes instructions that, when executed by processor 320, causes the wireless communications device 300 to perform the corresponding functions. The non-transitory computer-readable medium of memory 330 thus includes instructions for performing all or a portion of the operations described below with respect to FIGS. 8 and 9.

Processor 320 may be any suitable processor capable of executing scripts or instructions of one or more software programs stored in the wireless communications device 300 (e.g., within memory 330). For example, processor 320 may execute the PER monitoring SW module 334 to monitor PERs associated with MU-MIMO transmissions and a transmission power of the MU-MIMO transmissions. Processor 320 may also execute the MCS selection SW module 334 to adjust the MCS used for transmitting data to the STA (e.g., by selecting a new MCS) based at least in part on the PERs and transmission power associated with the MU-MIMO transmissions.

FIG. 4 shows an example PER table 400 that may be used to record PERs of wireless communications with a particular STA, in accordance with some embodiments. With reference, for example, to FIG. 1, the PER table 400 may be stored and/or updated by the AP 110 based on data transmissions to one of the stations STA1-STA3. More specifically, the AP 110 may use the PER table 400 to determine when and/or how to adjust (e.g., select) an MCS to be used for data transmissions to a particular STA.

The PER table 400 may store PER and goodput values associated with each data transmission to a particular STA, in relation to the MCS used for the data transmission. For example, a first column of the PER table 400 may store a number of MCS indices (e.g., 0-M) for the MCSs supported by the AP 110 and/or STA. The PER table 400 further includes respective columns for storing the PER and goodput of data transmissions of various types. In the example of FIG. 4, the types of data transmissions supported by the PER table 400 include single-user MIMO (SU-MIMO) transmissions and MU-MIMO transmissions of various group sizes (e.g., GS=2 to GS=N).

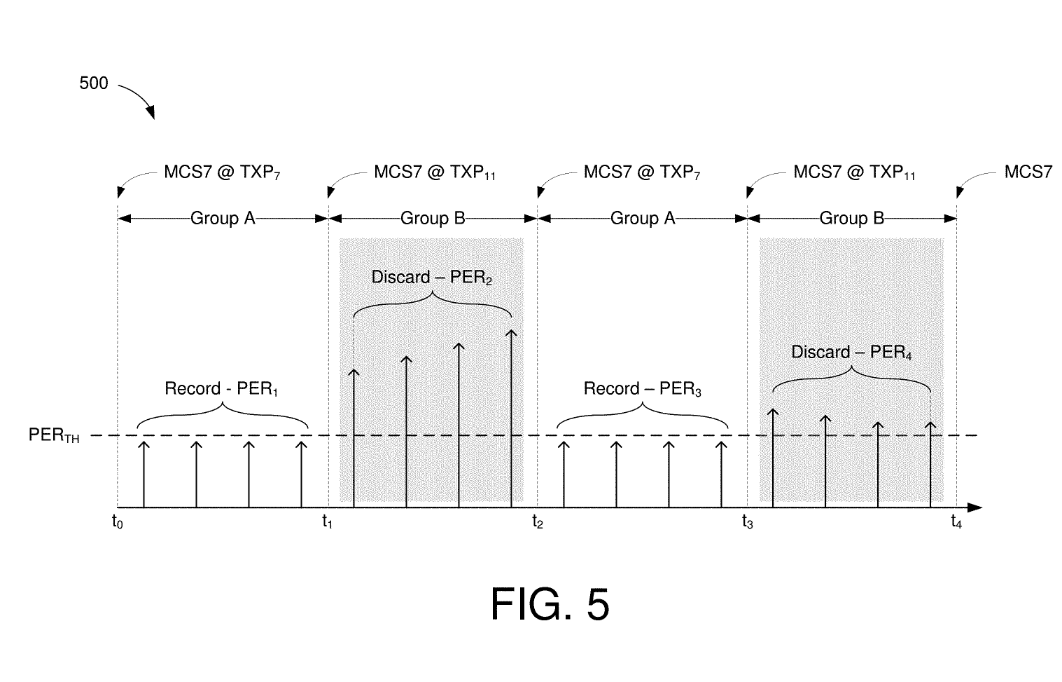

In example embodiments, the AP 110 may selectively update the entries in the PER table 400 based at least in part on the transmission power of the data transmissions. As described in greater detail below, with respect to FIG. 5, the AP 110 may record the PER associated with a particular data transmission only if the transmission power of the data transmission is equal (or at least substantially close) to the target transmission power for the given MCS (e.g., the MCS used for the data transmission). On the other hand, the AP 110 may discard (e.g., not record) the PER associated with the data transmission if the transmission power is not equal (or at least substantially close) to the target transmission power.

FIG. 5 shows a timing diagram 500 depicting an example power-based MCS selection/adjustment operation, in accordance with some embodiments. With reference, for example, to FIG. 1, the example operation of FIG. 5 may be performed by the AP 110 to selectively adjust an MCS to be used for MU-MIMO transmissions to STA1 based, at least in part, on the transmission power and packet error rates of prior MU-MIMO transmissions to STA1. For purposes of discussion, it may be assumed that the MCSs associated with the other stations STA2 and STA3 remain unchanged throughout the example of FIG. 5. For example, the AP 110 may use MCS3 for MU-MIMO transmissions to STA2, and MCS11 for MU-MIMO transmissions to STA3, for the entirety of the duration shown in FIG. 5 (e.g., from times t₀ to t₄).

At time t₀, the AP 110 may initiate a MU-MIMO transmission to STA1 as part of a beamformed signal intended for Group A (e.g., BF signal 101). MCS7 may be used for the MU-MIMO transmission (e.g., corresponding to the highest MCS currently supported by STA1). Because MCS7 is also the highest MCS associated with Group A, the MU-MIMO transmission may be at the target transmission power for MCS7 (e.g., TXP₇). The AP 110 may measure a first set of PERs (e.g., PER₁) associated with the MU-MIMO transmission. In example embodiments, the AP 110 may compare the transmission power of the MU-MIMO transmissions with the target transmission power associated with the given MCS (e.g., TXP₇ for MCS7) to determine whether to record, or to discard, the first set of PERs. Since the transmission power of the MU-MIMO transmission (TXP₇) is equal to the target transmission power for MCS7, the AP 110 may record the first set of PERs in a PER table (e.g., such as the PER table 400 shown in FIG. 4). The AP 110 may then use the first set of PERs to determine, at time t₁, whether to adjust the MCS for STA1. Since the first set of PERs (measured from times t₀ to t₁) is below the PER threshold (PER_{TH}), the AP 110 may continue using MCS7 for subsequent MU-MIMO transmissions to STA1.

At time t₁, the AP 110 may initiate a second MU-MIMO transmission to STA1 as part of a beamformed signal intended for Group B (e.g., BF signal 102). MCS7 may again be used for the second MU-MIMO transmission (e.g., since no adjustments were made based on PER₁). However, because MCS11 is the highest MCS associated with Group B, the second MU-MIMO transmission may be at the target transmission power for MCS11 (e.g., TXP₁₁). The AP 110 may measure a second set of PERs (e.g., PER₂) associated with the second MU-MIMO transmission. As described above, the AP 110 may compare the transmission power of the MU-MIMO transmission with the target transmission power associated with the given MCS (e.g., TXP₇ for MCS7). Since the transmission power of the second MU-MIMO transmission (TXP₁₁) is different than the target transmission power for MCS7, AP 110 may discard the second set of PERs (e.g., not record PER₂ in the PER table). Accordingly, the AP 110 may ignore the second set of PERs when determining, at time t₂, whether to adjust the MCS for STA1. For example, the AP 110 may continue to maintain the current MCS (e.g., as MCS7) for MU-MIMO transmissions to STA1 even though the second set of PERs (measured from times t₁ to t₂) is above PER_{TH}.

At time t₂, the AP 110 may initiate a third MU-MIMO transmission to STA1 as part of a beamformed signal intended for Group A (e.g., BF signal 101). MCS7 may again be used for the third MU-MIMO transmission (e.g., since no adjustments were made based on PER₂). Because MCS7 is also the highest MCS associated with Group A, the third MU-MIMO transmission may be at the target transmission power for MCS7 (e.g., TXP₇). The AP 110 may measure a third set of PERs (e.g., PER₃) associated with the third MU-MIMO transmission. Since the transmission power of the third MU-MIMO transmission (TXP₇) is equal to the target transmission power for MCS7, the AP 110 may record the third set of PERs in the PER table. The AP 110 may then use the third set of PERs to determine, at time t₃, whether to adjust the MCS for STA1. Since the third set of PERs (measured from times t₂ to t₃) is below PER_{TH}, the AP 110 may continue using MCS7 for subsequent MU-MIMO transmissions to STA1.

At time t₃, the AP 110 may initiate a fourth MU-MIMO transmission to STA1 as part of a beamformed signal intended for Group B (e.g., BF signal 102). MCS7 may continue to be used for the fourth MU-MIMO transmission (e.g., since no adjustments were made based on the PER₃). However, because MCS11 is the highest MCS associated with Group B, the fourth MU-MIMO transmission may be at the target transmission power for MCS11 (e.g., TXP₁₁). The AP 110 may measure a fourth set of PERs (e.g., PER₄) associated with the fourth MU-MIMO transmission. Since the transmission power of the fourth MU-MIMO transmission (TXP₁₁) is different from the target transmission power for MCS7, AP 110 may discard the fourth set of PERs. Accordingly, the AP 110 may ignore the fourth set of PERs when determining, at time t₄, whether to adjust the MCS for STA1. For example, the AP 110 may continue to maintain the current MCS (e.g., MCS7) for MU-MIMO transmissions to STA1 even though the fourth set of PERs (measured from times t₃ to t₄) is below PER_{TH}.

By discarding PERs associated with MU-MIMO transmissions at non-ideal transmission powers (e.g., any transmission power that is not equal to the target transmission power for the given MCS), the example embodiments may ensure that the AP 110 does not alter the MCS for a particular STA based on fluctuations in PER that could be attributed to varying transmission powers. For example, as shown in FIG. 5, the AP 110 may continue to use MCS7 for MU-MIMO transmissions to STA1 even though the measured PER exceed the PER threshold during certain transmission intervals (e.g., from times t₁ to t₂ and t₃ to t₄). In other words, the AP 110 may analyze the PERs of a prior MU-MIMO transmission only if the prior MU-MIMO transmission was at an ideal or target transmission power for the given MCS. Therefore, by selectively updating the PER table based on transmission power, the PER values stored in the PER table may more accurately reflect the suitability of a given MCS for a particular STA.

In another embodiment, rather than discard the PERs for MU-MIMO transmissions at non-ideal transmission powers, the AP 110 may record the PERs and transmission power associated with each MU-MIMO transmission. As described in greater detail below, when initiating an MU-MIMO transmission to a particular STA, the AP 110 may then determine whether and/or how to adjust the MCS to be used for the MU-MIMO transmission based at least in part on a scheduled transmission power of the associated beamformed signal (e.g., for the MU group to which the STA belongs). For example, in selecting the MCS for the particular MU-MIMO transmission, the AP 110 may analyze the PERs associated only with the scheduled transmission power.

FIG. 6 shows an example PER table 600 that may be used to record PERs of wireless communications with a particular STA, in accordance with other embodiments. With reference, for example, to FIG. 1, the PER table 600 may be stored and/or updated by the AP 110 based on data transmissions to one of the stations STA1-STA3. More specifically, the AP 110 may use the PER table 600 to determine when and/or how to adjust (e.g., select) an MCS to be used for data transmissions to a particular STA based at least in part on the transmission power of previous MU-MIMO transmissions.

The PER table 600 may store PER and goodput values associated with each data transmission to a particular STA, in relation to the MCS used for the data transmission and the transmission power of the data transmission. More specifically, the PER table 600 may include a respective sub-table for each of the transmission powers TXP₁-TXP_{K} supported by the AP 110. For example, a first column of each sub-table may store a number of MCS indices (e.g., 0-M) for the MCSs supported by the AP 110 and/or STA. Each sub-table further includes respective columns for storing the PER and goodput of data transmissions of various types. In the example of FIG. 6, the types of data transmissions supported by the PER table 600 include SU-MIMO transmissions and MU-MIMO transmissions of various group sizes (e.g., GS=2 to GS=N).

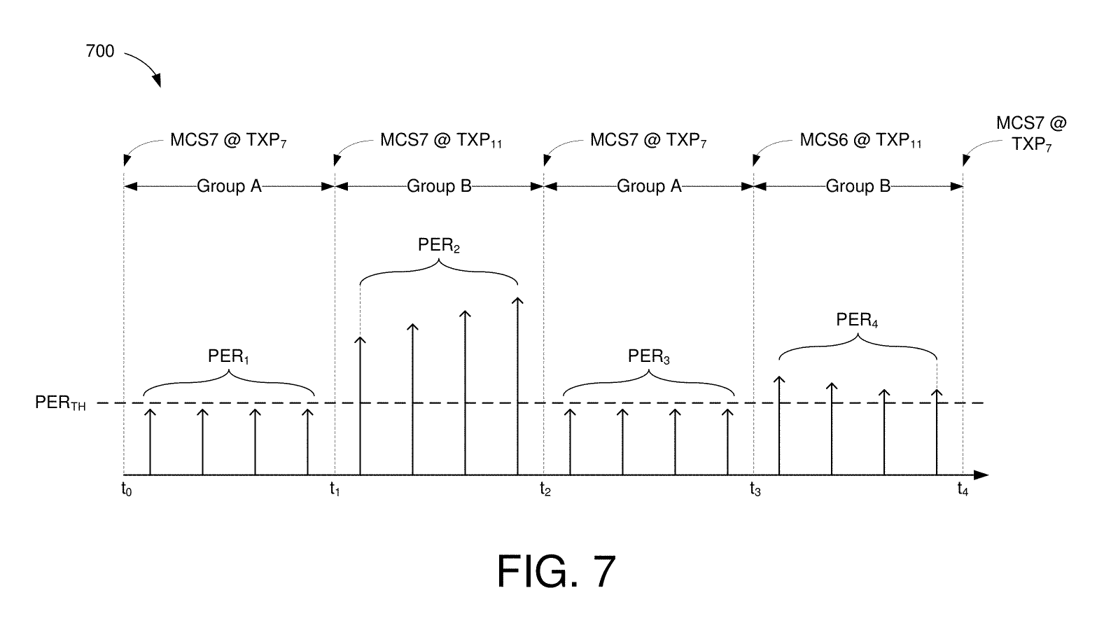

In example embodiments, the AP 110 may update the entries in the PER table 600 according to the transmission power of the data transmissions. As described in greater detail below, with respect to FIG. 7, the AP 110 may record the PER associated with a particular data transmission in the appropriate sub-table corresponding to the transmission power of the data transmission. For actual implementations, the PER table 600 may include sub-tables for a predetermined number of (e.g., frequently used) transmission powers, so that the PER table 600 may be kept to a reasonable size.

FIG. 7 shows a timing diagram 700 depicting an example power-based MCS selection/adjustment operation, in accordance with other embodiments. With reference, for example, to FIG. 1, the example operation of FIG. 7 may be performed by the AP 110 to adjust an MCS to be used for MU-MIMO transmissions to STA1 based, at least in part, on the transmission power and packet error rates of prior MU-MIMO transmissions to STA1. For purposes of discussion, it may be assumed that the MCSs associated with the other stations STA2 and STA3 remain unchanged throughout the example of FIG. 7. For example, the AP 110 may use MCS3 for MU-MIMO transmissions to STA2, and MCS11 for MU-MIMO transmissions to STA3, for the entirety of the duration shown in FIG. 7 (e.g., from times t₀ to t₄).

At time t₀, the AP 110 may initiate a MU-MIMO transmission to STA1 as part of a beamformed signal intended for Group A (e.g., BF signal 101). MCS7 may be used for the MU-MIMO transmission (e.g., corresponding to the highest MCS currently supported by STA1). Because MCS7 is also the highest MCS associated with Group A, the MU-MIMO transmission may be at the target transmission power for MCS7 (e.g., TXP₇). The AP 110 may measure a first set of PERs (e.g., PER₁) associated with the MU-MIMO transmission, and may record the first set of PERs for MCS7 in a PER table (e.g., PER table 600 of FIG. 6) in relation to the transmission power of the MU-MIMO transmission (TXP₇). For example, the AP 110 may use the first set of PERs to determine whether to adjust the MCS for subsequent MU-MIMO transmissions at the same transmission power (e.g., TXP₇).

At time t₁, the AP 110 may initiate a second MU-MIMO transmission to STA1 as part of a beamformed signal intended for Group B (e.g., BF signal 102). In example embodiments, for purposes of determining the transmission power of the beamformed signal, the AP 110 may initially assume a “default MCS” for STA1. The default MCS may correspond to the MCS determined for the STA based on MU-MIMO transmissions at the target transmission power for that MCS. In the example of FIG. 7, MCS7 may be the default MCS for STA1. Since MCS7 is the default MCS associated with STA1, the AP 110 may determine that MCS11 is the highest MCS associated with Group B and may configure the transmission power of the beamformed signal for Group B to correspond to the target transmission power for MCS11 (e.g., TXP₁₁). Upon determining the transmission power of the beamformed signal, the AP 110 may then selectively adjust the MCS to be used for subsequent MU-MIMO transmissions to STA1 based, at least in part, on PERs associated with previous MU-MIMO transmissions at the given transmission power (e.g., TXP₁₁).

For example, with reference to the PER table 600 of FIG. 6, the AP 110 may analyze the PERs recorded in the sub-table associated with TXP₁₁ for determining whether and/or how to adjust the MCS for STA1. In the example of FIG. 7, the AP 110 may once again select MCS7 to be used for the second MU-MIMO transmission (e.g., assuming no adjustments were made based on the PERs recorded for prior MU-MIMO transmissions at TXP₁₁). The AP 110 may measure a second set of PERs (e.g., PER₂) associated with the second MU-MIMO transmission, and may record the second set of PERs for MCS7 in a PER table (e.g., PER table 600 of FIG. 6) in relation to the transmission power of the second MU-MIMO transmission (TXP₁₁). For example, the AP 110 may use the second set of PERs to determine whether to adjust the MCS for subsequent MU-MIMO transmissions at the same transmission power (e.g., TXP₁₁).

At time t₂, the AP 110 may initiate a third MU-MIMO transmission to STA1 as part of a beamformed signal intended for Group A (e.g., BF signal 101). As described above, for purposes of determining the transmission power of the beamformed signal, the AP 110 may once again assume the default MCS for STA1 (e.g., MCS7). Since MCS7 is the default MCS associated with STA1, the AP 110 may determine that MCS7 is also the highest MCS associated with Group A and may configure the transmission power of the beamformed signal for Group A to correspond to the target transmission power for MCS7 (e.g., TXP₇). The AP 110 may then selectively adjust the MCS to be used for subsequent MU-MIMO transmissions to STA1 based, at least in part, on PERs associated with previous MU-MIMO transmissions at the given transmission power (e.g., TXP₇).

For example, with reference to the PER table 600 of FIG. 6, the AP 110 may analyze the PERs recorded in the sub-table associated with TXP₇ for determining whether and/or how to adjust the MCS for STA1. Since the first set of PERs (e.g., recorded in the PER table in relation to MCS7 and TXP₇) is below the PER threshold (PER_{TH}), the AP 110 may continue using MCS7 for the third MU-MIMO transmission. The AP 110 may measure a third set of PERs (e.g., PER₃) associated with the third MU-MIMO transmission, and may record the third set of PERs for MCS7 in the PER table in relation to the transmission power of the third MU-MIMO transmission (TXP₇). For example, the AP 110 may use the third set of PERs to determine whether to adjust the MCS for subsequent MU-MIMO transmissions at the same transmission power (e.g., TXP₇). Therefore, in doing so, AP 110 is aware of the current transmission power for the MU-MIMO transmission to STA1, and may dynamically select the MCS for STA1 taking into account the PERs measured for previous MU-MIMO transmissions at the same transmission power.

At time t₃, the AP 110 may initiate a fourth MU-MIMO transmission to STA1 as part of a beamformed signal intended for Group B (e.g., BF signal 102). Because MCS11 is the highest MCS associated with Group B (e.g., assuming MCS7 is still the default MCS for STA1), the AP 110 may configure the transmission power of the beamformed signal for Group B to correspond to the target transmission power for MCS11 (e.g., TXP₁₁). The AP 110 may then selectively adjust the MCS to be used for the fourth MU-MIMO transmission to STA1 based, at least in part, on PERs associated with previous MU-MIMO transmissions at the given transmission power (e.g., TXP₁₁). Since the second set of PERs (e.g., recorded in the PER table in relation to MCS7 and TXP₁₁) is above PER_{TH}, the AP 110 may reduce the MCS (e.g., to MCS6) for the fourth MU-MIMO transmission. The AP 110 may measure a fourth set of PERs (e.g., PER₄) associated with the fourth MU-MIMO transmission, and may record the fourth set of PERs for MCS6 in the PER table in relation to the transmission power of the third MU-MIMO transmission (TXP₁₁).

At time t₄, the AP 110 may initiate a fifth MU-MIMO transmission to STA1 as part of a beamformed signal intended for Group A (e.g., BF signal 101). Although MCS6 was last used for MU-MIMO transmissions to STA1, for purposes of determining the transmission power of the beamformed signal, the AP 110 may once again assume MCS7 to be the default MCS for STA1 (e.g., since the fourth MU-MIMO transmission was not at the target transmission power for MCS6). Since MCS7 is also the highest MCS associated with Group A, the AP 110 may configure the transmission power of the beamformed signal for Group A to correspond to the target transmission power for MCS7 (e.g., TXP₇). The AP 110 may then selectively adjust the MCS to be used for the fifth MU-MIMO transmission to STA1 based, at least in part, on PERs associated with previous MU-MIMO transmissions at the given transmission power (e.g., TXP₇). Since the first and third sets of PERs (e.g., recorded in the PER table in relation to MCS7 and TXP₇) are below PER_{TH}, the AP 110 may once again use MCS7 for the fifth MU-MIMO transmission.

By recording the PERs for MU-MIMO transmissions in relation to the transmission power of the MU-MIMO transmissions, the example embodiments may ensure that the AP 110 does not alter the MCS for a particular STA based on fluctuations in PER that could be attributed to varying transmission powers. Further, the example embodiments allow the AP 110 to more precisely adjust the MCS for a particular STA based on the STA's membership in an MU group. For example, as shown in FIG. 7, the AP 110 may reduce the MCS for STA1 (e.g., from MCS7 to MCS6) for MU-MIMO transmissions intended for STA1 as a member of Group B. In contrast, the AP 110 may maintain the default MCS (e.g., MCS7) for STA1 for MU-MIMO transmissions intended for STA1 as a member of Group A.

FIG. 8 is an illustrative flowchart depicting a method for MU-MIMO communications with a particular station, in accordance with example embodiments. With reference, for example, to FIG. 1, the method 800 may be implemented by the AP 110 to select and/or adjust an MCS to be used for transmitting data to STA1.

The AP 110 may initiate MU-MIMO transmissions to the STA according to a first MCS and a first transmission power (810). In some aspects, the first MCS may correspond to an initial MCS selected by the AP 110 for MU-MIMO transmissions to the particular STA. For example, the AP 110 may determine the initial MCS based on a number of factors (e.g., predicted path loss, channel state information, signal strength, PER, etc.) associated with the given communications channel. In other aspects, the first MCS may correspond to an adjusted MCS based on prior MU-MIMO transmissions to the STA. For example, the AP 110 may adjust the MCS associated with the STA based, at least in part, on a PER associated with the prior MU-MIMO transmissions.

The AP 110 may monitor PERs associated with the MU-MIMO transmissions to the STA (820). For example, the AP 110 may record and/or update the PER values in a PER table (e.g., PER table 400 of FIG. 4 or PER table 600 of FIG. 6) in relation to the MCS used for the MU-MIMO transmissions. For some embodiments, the AP 110 may selectively record and/or update the PER values, in a PER table, based on the first transmission power (822). For example, as described above with respect to FIGS. 4 and 5, the AP 110 may discard the PER values (e.g., not record the PER values in the PER table 400) if the transmission power is not equal to the target transmission power for the given MCS. In other embodiments, the AP 110 may record the PER values, in the PER table, in relation to the first transmission power (824). For example, as described above with respect to FIGS. 6 and 7, the AP 110 may record the PER values in the appropriate sub-table, of the PER table 600, corresponding to the first transmission power.

The AP 110 may then select a second MCS to be used for subsequent MU-MIMO transmissions to the STA based, at least in part, on the PERs and the first transmission power (830). For example, the AP 110 may refer to the PER table (e.g., PER table 400 and/or 600), in determining whether and/or how to adjust the MCS for subsequent MU-MIMO transmissions to STA1. For some embodiments, the AP 110 may compare the first transmission power with a target transmission power for the first MCS in selecting the second MCS (832). More specifically, in determining how to adjust the MCS, the AP 110 may analyze only the PER values associated with MU-MIMO transmissions at the target transmission power for the given MCS. For example, the AP 110 may ignore the PER values associated with the MU-MIMO transmissions if the MU-MIMO transmissions are not at the target transmission power for the first MCS.

FIG. 9 is an illustrative flow chart depicting a method for selecting an MCS to be used for MU-MIMO transmissions based on transmission power, in accordance with some embodiments. With reference, for example, to FIG. 1, the method 900 may be implemented by the AP 110 to select and/or adjust an MCS to be used for MU-MIMO transmissions to STA1. More specifically, the AP 110 may determine whether and/or how to adjust an MCS associated with STA1 based, at least in part, on a transmission power of MU-MIMO transmissions to STA1. For purposes of discussion, a first MCS may be used for the MU-MIMO transmissions.

The AP 110 compares the transmission power of MU-MIMO transmissions with a target transmission power associated with the first MCS (910). For example, the target transmission power may be ideal for MU-MIMO transmissions according to the first MCS. As described above, the transmission power of the MU-MIMO transmissions may be affected by the member STAs of the corresponding MU group. More specifically, the AP 110 may configure the transmission power of a beamformed signal (e.g., including MU-MIMO transmissions for each STA belonging to the MU group) intended for the MU group to be equal to the target transmission power for the highest MCS associated with any of the STAs in the MU group.

In example embodiments, the AP 110 may determine whether the transmission power of the MU-MIMO transmissions is substantially equal to the target transmission power (920). As described above, the example embodiments recognize that variations in transmission power may affect the accuracy and/or reliability of the MU-MIMO transmissions. For example, the AP 110 may detect a higher PER associated with the MU-MIMO transmissions if transmitted at a non-ideal transmission power (e.g., compared to the ideal transmission power for the first MCS).

Thus, if the transmission power of the MU-MIMO transmissions is equal to the target transmission power (as tested at 920), the AP 110 may use the PERs associated with the MU-MIMO transmissions in selecting a second MCS to be used for subsequent MU-MIMO transmissions to the STA (930). For example, the AP 110 may record the PERs associated with the MU-MIMO transmissions in a PER table (e.g. PER table 400 of FIG. 4 and/or PER table 600 of FIG. 6) upon determining that the transmission power of the MU-MIMO transmissions is substantially equal to the target transmission power. The AP 110 may then access the PER values stored in the PER table to determine whether and/or how to adjust the MCS (e.g., as the second MCS) for the subsequent MU-MIMO transmissions.

However, if the transmission power of the MU-MIMO transmissions is not equal to the target transmission power (as tested at 920), the AP 110 may ignore the PERs associated with the MU-MIMO transmissions in selecting the second MCS to be used for subsequent MU-MIMO transmissions to the STA (940). For some embodiments, the AP 110 may discard the PERs associated with the MU-MIMO transmissions (e.g., not record the PERs in the PER table 400) upon determining that the transmission power of the MU-MIMO transmissions is not equal to the target transmission power. In other embodiments, the AP 110 may record the PERs associated with the MU-MIMO transmissions in an appropriate sub-table, of the PER table 600, in relation to the transmission power. The AP 110 may subsequently ignore such PER values (e.g., as stored in the PER table 600) when determining whether and/or how to adjust the MCS (e.g., as the second MCS) for the subsequent MU-MIMO transmissions.

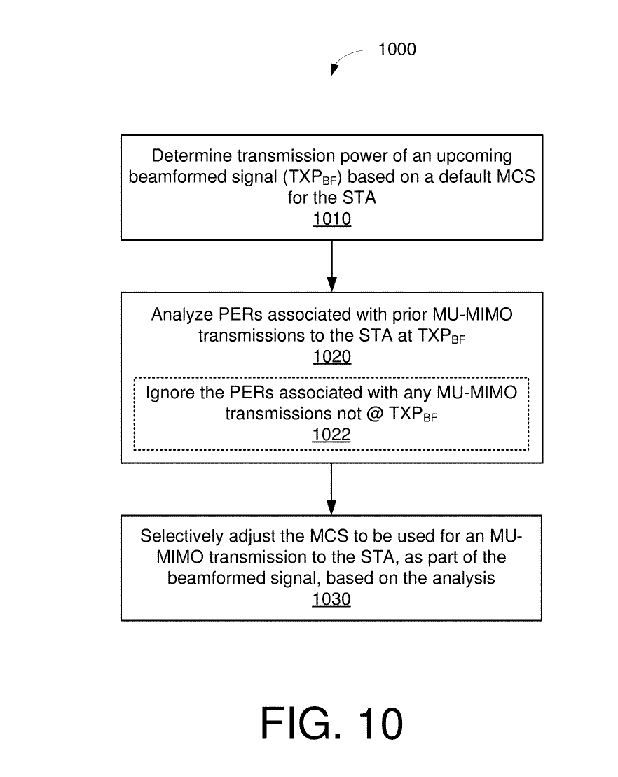

FIG. 10 is an illustrative flowchart depicting a method of selecting an MCS to be used for MU-MIMO transmissions based on transmission power, in accordance with other embodiments. With reference, for example, to FIG. 1, the method 1000 may be implemented by the AP 110 to select and/or adjust an MCS to be used for MU-MIMO transmissions to STA1. More specifically, the AP 110 may determine whether and/or how to adjust a default MCS associated with STA1 based, at least in part, on a scheduled transmission power to be used for upcoming MU-MIMO transmissions to STA1.

The AP 110 may determine the transmission power of an upcoming beamformed signal (TX_{BF}), to be used for MU-MIMO transmissions to the STA, based on a default MCS for the STA (1010). As described above, the default MCS may correspond to the MCS determined for the STA based on MU-MIMO transmissions at the target transmission power for that MCS. For example, with reference to FIG. 7, the default MCS for STA1 is MCS7. In example embodiments, the AP 110 may configure the transmission power of the upcoming beamformed signal to correspond to the target transmission power of the highest MCS supported by the corresponding MU group (e.g., assuming the default MCS for the given STA). For example, if the default MCS for STA1 is the highest MCS among the members of the MU group to which STA1 belongs, then transmission power of the upcoming beamformed signal may be set to the target transmission power for the default MCS associated with STA1.

The AP 110 may then analyze PERs associated with prior MU-MIMO transmissions to the STA at the transmission power of the upcoming beamformed signal (1020). For some embodiments, the AP 110 may ignore any PERs associated with MU-MIMO transmissions at any other transmission powers (1022). For example, with reference to FIG. 6, the AP 100 may analyze the PER values stored in the sub-table, of the PER table 600, associated with the corresponding transmission power. Further, the AP 110 may ignore the PER values stored in any of the remaining sub-tables of the PER table 600 (e.g., associated with any transmission power other than the transmission power of the upcoming beamformed signal).

The AP 110 may selectively adjust the MCS to be used for an MU-MIMO transmission to the STA, as part of the upcoming beamformed signal, based on the analysis (1030). For example, the AP 110 may determine whether to maintain the default MCS for the STA, or to select a higher or lower MCS, by comparing the PER values in the corresponding sub-table of the PER table 600 with a PER threshold (e.g., PER_{TH}). In some aspects, the AP 110 may determine whether and/or how to adjust the MCS based on the PER values associated with the default MCS. For example, the AP 110 may select a lower MCS if the average PER values for the default MCS exceed the PER threshold. On the other hand, the AP 110 may maintain the default MCS (or select a higher MCS) if the average PER values for the default MCS are below the PER threshold. In other aspects, the AP 110 may determine whether and/or how to adjust the MCS based on PER values associated with other MCSs recorded in the corresponding sub-table (e.g., of the PER table 600). For example, the AP 110 may analyze the PER values recorded for each MCS in the sub-table. The AP 110 may then select the highest MCS with average PER values below the PER threshold.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, the example embodiments have been described with reference to specific example embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

In the foregoing specification, embodiments have been described with reference to specific examples. It will, however, be evident that various modifications and changes may be made thereto without departing from the broader scope of the disclosure as set forth in the appended claims. For example, the method steps depicted in the flow charts of FIGS. 8-10 may be performed in other suitable orders, multiple steps may be combined into a single step, and/or some steps may be omitted (or further steps included). The specification and drawings are, accordingly, to be regarded in an illustrative sense rather than a restrictive sense.

What is claimed is:

1. A method for multi-user multiple-input multiple-output (MU-MIMO) communications, the method comprising:
initiating MU-MIMO transmissions to a station (STA) according to a first modulation and coding scheme (MCS) and a first transmission power;
monitoring packet error rates (PERs) associated with the MU-MIMO transmissions to the STA; and
selecting a second MCS to be used for subsequent MU-MIMO transmissions to the STA based, at least in part, on the PERs and the first transmission power.

2. The method of claim 1, wherein the selecting comprises:
determining a target transmission power associated with the first MCS;
comparing the target transmission power with the first transmission power; and
selecting the second MCS based, at least in part, on the comparison.

3. The method of claim 2, wherein the selecting further comprises:
using the PERs, associated with the MU-MIMO transmissions, in selecting the second MCS if the target transmission power and the first transmission power are substantially the same.

4. The method of claim 2, wherein the selecting further comprises:
ignoring the PERs, associated with the MU-MIMO transmissions, in selecting the second MCS if the target transmission power and the first transmission power are different.

5. The method of claim 1, further comprising:
recording the PERs associated with the MU-MIMO transmissions, in a PER table, in relation to the first transmission power.

6. The method of claim 5, further comprising:
recording the PERs associated with the MU-MIMO transmissions, in the PER table, in relation to a group size associated with the MU-MIMO transmissions.

7. The method of claim 1, wherein the monitoring comprises:
selectively recording the PERs in a PER table based on the first transmission power.

8. The method of claim 7, wherein the selectively recording comprises:
determining a target transmission power associated with the first MCS; and
recording the PERs, associated with the MU-MIMO transmissions, in the PER table if the first transmission power and the target transmission power are substantially the same.

9. The method of claim 7, wherein the selectively recording comprises:
determining a target transmission power associated with the first MCS; and
discarding the PERs, associated with the MU-MIMO transmissions, from the PER table if the first transmission power and the target transmission power are different.

10. The method of claim 1, wherein the MU-MIMO transmissions are intended for the STA as a member of a first multi-user (MU) group, and wherein the subsequent MU-MIMO transmissions are intended for the STA as a member of a second MU group.

11. A wireless communications device, comprising:
one or more processors; and
a memory storing instructions that, when executed by the one or more processors, cause the wireless communications device to:
initiate multi-user multiple-input multiple-output (MU-MIMO) transmissions to a station (STA) according to a first modulation and coding scheme (MCS) and a first transmission power;
monitor packet error rates (PERs) associated with the MU-MIMO transmissions to the STA; and
select a second MCS to be used for subsequent MU-MIMO transmissions to the STA based, at least in part, on the PERs and the first transmission power.

12. The wireless communications device of claim 11, wherein execution of the instructions to select the second MCS causes the communications device to:
determine a target transmission power associated with the first MCS;
compare the target transmission power with the first transmission power; and
select the second MCS based, at least in part, on the comparison.

13. The wireless communications device of claim 12, wherein execution of the instructions to select the second MCS further causes the communications device to:
use the PERs, associated with the MU-MIMO transmissions, in selecting the second MCS if the target transmission power and the first transmission power are substantially the same.

14. The wireless communications device of claim 12, wherein execution of the instructions to select the second MCS further causes communications the device to:
ignore the PERs, associated with the MU-MIMO transmissions, in selecting the second MCS if the target transmission power and the first transmission power are different.

15. The wireless communications device of claim 11, wherein execution of the instructions to monitor the PERs further causes the communications device to:
record the PERs associated with the MU-MIMO transmissions, in a PER table, in relation to the first transmission power.

16. The wireless communications device of claim 15, wherein execution of the instructions to monitor the PERs further causes the communications device to:
record the PERs associated with the MU-MIMO transmissions, in the PER table, in relation to a group size associated with the MU-MIMO transmissions.

17. The wireless communications device of claim 11, wherein execution of the instructions to monitor the PERs causes the communications device to:
selectively record the PERs in a PER table based on the first transmission power.

18. The wireless communications device of claim 17, wherein execution of the instructions to selectively record the PERs causes the communications device to:
determine a target transmission power associated with the first MCS; and
record the PERs, associated with the MU-MIMO transmissions, in the PER table if the first transmission power and the target transmission power are substantially the same.

19. The wireless communications device of claim 17, wherein execution of the instructions to selectively record the PERs causes the communications device to:
determine a target transmission power associated with the first MCS; and
discard the PERs, associated with the MU-MIMO transmissions, from the PER table if the first transmission power and the target transmission power are different.

20. A non-transitory computer-readable storage medium storing instructions that, when executed by a processor of a wireless communications device, causes the wireless communications device to:
initiate multi-user multiple-input multiple-output (MU-MIMO) transmissions to a station (STA) according to a first modulation and coding scheme (MCS) and a first transmission power;
monitor packet error rates (PERs) associated with the MU-MIMO transmissions to the STA; and
select a second MCS to be used for subsequent MU-MIMO transmissions to the STA based, at least in part, on the PERs and the first transmission power.
